(19) United States
(12) Patent Application Publication
(10) Pub. No.: US 2008/0033887 A1
(43) Pub. Date: Feb. 7, 2008

(54) System and Method for A Television Investing Show

(76) Inventor: Donald Spector, New York, NY (US)

Correspondence Address: DIEHL SERVILLA LLC, 77 BRANT AVE, SUITE 210, CLARK, NJ, 07066, US

(21) Appl. No.: 11/462,830

(22) Filed: Aug. 7, 2006

(51) Int. Cl. G06Q 40/00

(52) U.S. Cl. 705/36 R

(57) ABSTRACT

A television show having investors, target companies, advisors and an audience is described. The investors make investment decisions with a predetermined sum of money based on presentations about the companies and advisor information. The audience can also invest. Expenses associated with the investments can be deducted. The results are tracked, and the investor with the highest account value at the end of a period is declared the winner.

### BACKGROUND OF THE INVENTION

This invention relates to investing and to television shows, including reality television shows.

The public is more interested in investing than ever before. Through Internet investing sites, they are participating in the stock market in greater numbers. There are many television shows presenting stock market information, views and perspectives, but none of these shows provides any type of reality investing.

Accordingly, new and improved television shows relating to investing are needed.

### SUMMARY OF THE INVENTION

In accordance with one aspect of the present invention, a method of presenting a television show is provided. Each of a plurality of investors is provided with a predetermined sum of money. Then, a presentation of information about a plurality of companies to the plurality of investors is made and televised. Each of the plurality of investors invests the predetermined sum of money in the plurality of companies and this step is also preferably televised.

In accordance with a further aspect of the present invention, the results of the steps of investing the predetermined sum of money are tracked for each of the plurality of investors and the results are televised.

Each of the plurality of investors can redistribute their investments in the plurality of companies in future shows. The investments are made in accordance with each investor's understanding of the market and the companies.

In accordance with a further aspect of the present invention, it is determined which of the plurality of investors has the most money. This can be done after any number of shows.

In accordance with another aspect of the present invention, the expenses associated with making the investments are deducted from each investor's account.

One or more advisors can be provided. The investors can ask any of the advisors for their opinions on the companies being presented, on market conditions or on any other relevant matter. This step is also preferably televised. The advice can be provided privately to the investor making the request, but can be shown to the entire audience, including a live audience and a television audience.

In accordance with another aspect of the present invention, an investor is charged an expense for asking advice from one or more advisors. This expense is deducted from the investor's account.

Each of the plurality of companies are preferably start-up companies. The presentation of information of each of the plurality of companies is preferably made by a representative of the company. Each of the plurality of investors are preferably not professional investors.

In accordance with a further aspect of the present invention, one or more members of an audience watching the presentation of information about the plurality of companies make investments in the plurality of companies. The investment results of the or more members of the audience are tracked and it is determined which one of the one or more members of the audience had the best investment results.

### DESCRIPTION OF THE DRAWINGS

FIG. 1 illustrates a television show in accordance with one aspect of the present invention.

FIG. 2 illustrates a system in accordance with another aspect of the present invention.

FIG. 3 illustrates the investment in a plurality of companies by a plurality of investors in accordance with one aspect of the present invention.

FIG. 4 illustrates the deduction of expenses from each of the plurality of investors in accordance with a further aspect of the present invention.

FIG. 5 illustrates tracking the results of each of the plurality of investors in accordance with another aspect of the present invention.

### DESCRIPTION OF A PREFERRED EMBODIMENT

In accordance with one aspect of the present invention, a television show consists of representatives of several public companies who answer questions from guests. Each of the guests (the contestants) have money to “invest” in shares of these companies at the closing price of the day of the broadcast.

The show is broadcast live through any medium (TV, internet, radio etc.), though re-runs can be edited to show advances (or declines) of the stock from preceding shows.

At the beginning of the following segment of the show, the “investments of the guests” from the previous show are evaluated. The winner is the guest whose stock portfolio increased the most by actual stock purchases from the public.

The public audience can either believe in the stock (or the guest) and vote, along with other investors, by purchasing stock in the companies on the open market.

Preferably, there is no non-public information given and the show will announce that they do have an interest in all companies that appear on the show.

This show will primarily feature little-known public companies, which will benefit from the exposure on a TV (or other type of broadcast) show. However, the public, as in the regular marketplace, will make their decision by voting with their own money through the purchase of stock.

In accordance with another aspect of the present invention, there may be experienced analysts who can be called upon for questions (which the guests will have to pay for from their money). Guest may include figures from the financial world, celebrities and people off the street.

The show can be called Company Tonight. The companies presented on the television show of the present invention will play a starring role in Company Tonight.

Company Tonight is the only show where the public audience can also “win” and make money along with the guests (contestants). Their investments also can increase in value from segment to segment depending on whether the stocks they purchase go up.

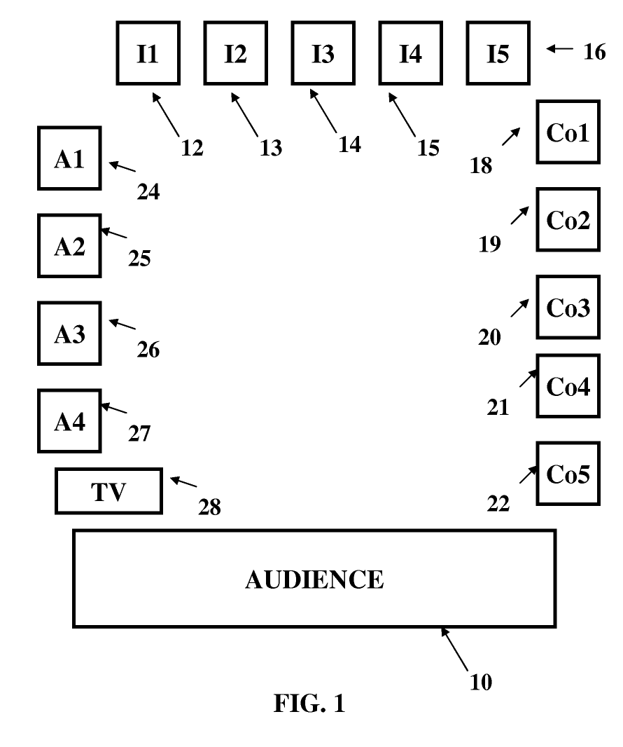

Various aspects of the present invention are illustrated in FIGS. 1 to 4. FIG. 1 illustrates an audience 10, five investors or guests 12 to 16, five companies 18 to 22 and four analysts 24 to 27. A plurality of television cameras 28 are also provided to be able to televise the activities of these participants. Of course, any number of each category of participants can be provided.

Representatives from each of the five companies 18 to 22 provide a presentation concerning their company. The information is preferably publicly available information. The information can, by way of example only, include the products or services marketed by the company, the financial results of the company, the company's strategic position and a description of the competitive marketplace. The plurality of television cameras 28 tape and televise the presentations about each of the companies 18 to 22.

The investors 12 to 16, members of the audience (both the live audience and a television audience), and the analysts 24 to 27 all watch the presentations about each of the companies 18 to 22. The investors 12 to 16 can ask any of the analysts 24 to 27 for their advice about investing in the companies 18 to 22.

The investors 12 to 16 are preferably provided with a predetermined sum of money. The investors 12 to 16 are preferably provided with the money by the television show.

The investors 12 to 16 invest the predetermined sums of money in the companies 18 to 22. At the end of each day, the results of the investments made by each of the investors 12 to 16 are tracked. At the end of a predetermined period of time, the investor 12 to 16 with the most money is determined and a winner is determined.

The expense of investing in each stock is determined and deducted from the account of each of the investors 12 to 16. The trades are preferably made on one of the Internet trading sites. Any of the investors 12 to 16 who chose to ask the analysts 24 to 27 for advice are charged a fee for that advice and that fee is deducted from the account of each of the investors 12 to 16. Thus, each investor 12 to 16 is charged fees for the trades and the advice received, forcing the investor 12 to 16 to make appropriate strategic decisions about who to talk to.

In accordance with another aspect of the present invention, each of the investors 12 to 16 can be given the opportunity to redistribute their investments on future days on future shows. So, for example, an investor 12 can sell some of his shares in a first company 18 and buy additional shares in a second company 19 if the investor 12 finds that the prospects for the first company 18 are dimming and the prospects for the second company 19 are improving. The results from each day are tracked and televised. A winning investor 12 to 16 is eventually determined and declared.

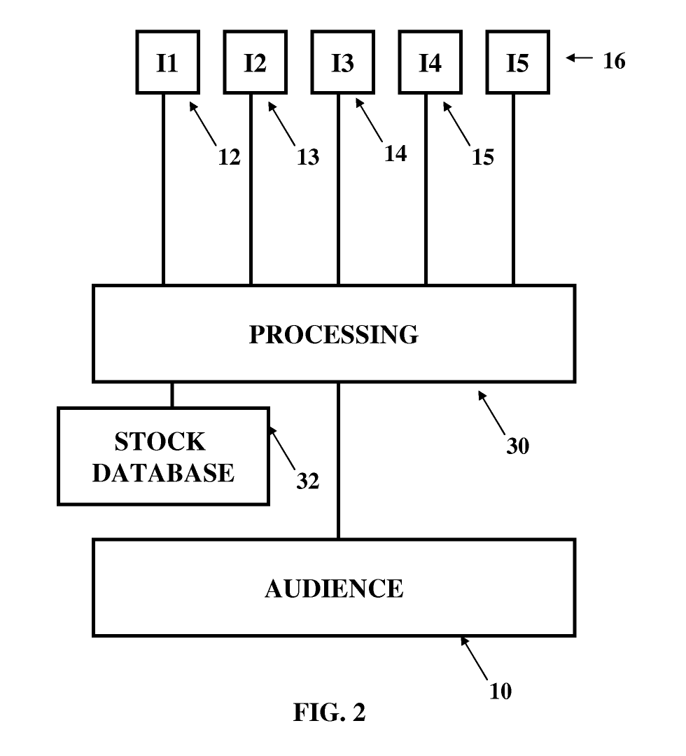

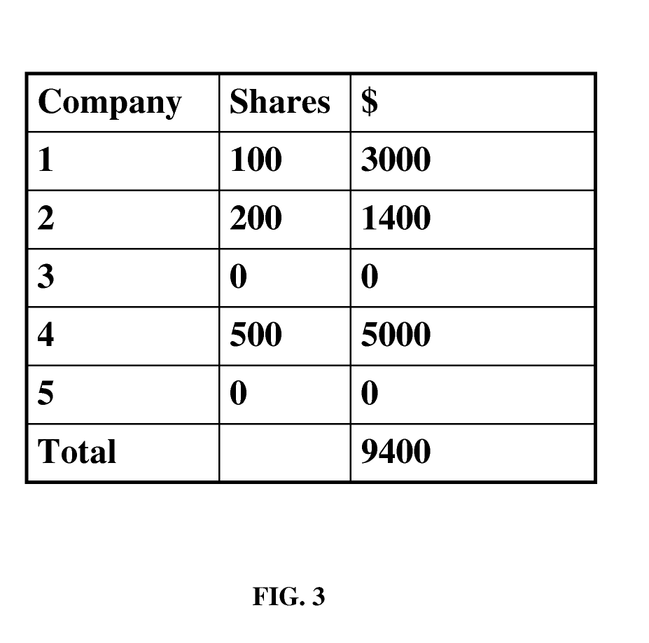

FIG. 2 illustrates a system in accordance with another aspect of the present invention. The members of the audience 10 and the investors/guests 12 to 16 are connected to a processing system 30. The processing system 30 receives investment decisions from the audience 10 and the investors 12 to 16 and records and tracks the information to be able to determine a winner. The processing system 30 performs all of the functions described herein, including those illustrated in FIGS. 3 to 5. The processing system 30 is connected to a stock database 32 so that the processing system 30 can obtain information about the prices of the stocks associated with the companies 18 to 22.

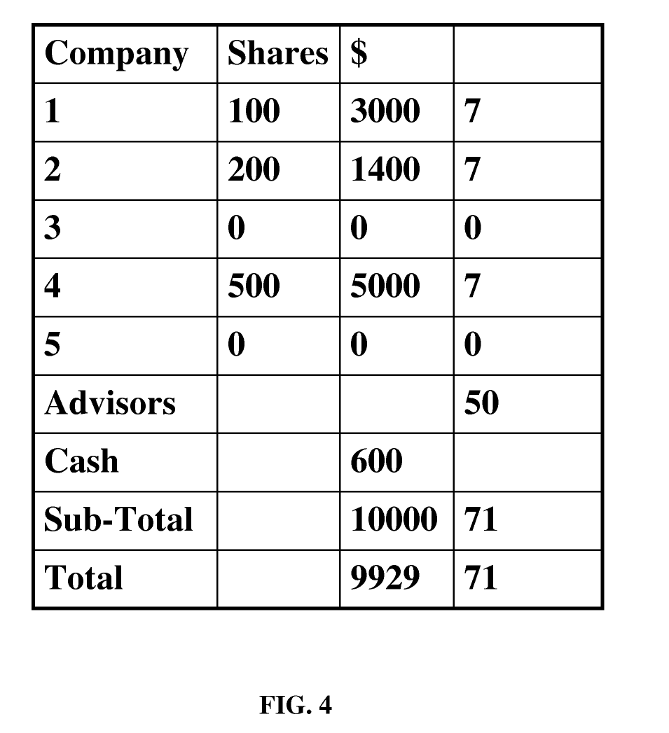

FIG. 3 illustrates the investment in a plurality of companies by one of the plurality of investors in accordance with one aspect of the present invention. The number of shares of each company 18 to 22 bought by the investor 12 and the dollar value of each of these investments is maintained. Similar information for each investor is maintained. Thus, referring to FIG. 4, investor 10 bought 100 shares of Company 1 at $30 per share for $3000, 200 shares of Company 2 at $7 per share for $1400 and 500 shares of Company 4 at $10 per share for $5000.

It is preferred to deduct expenses associated with the investment to be able to realistically track performance. FIG. 4 illustrates the deduction of expenses from each of the plurality of investors in accordance with a further aspect of the present invention. For each trade, which is preferably executed on an internet trading site but could be executed using any broker, a broker's fee is deducted. The broker's fee is, for example, $7.

If an investor asks an advisor or analyst 24 to 27 for advice, the investor is billed for the advice, just as a real-life investor would be. The charge is, by way of example only, $50 per request. The charge is deducted from the investor's account. FIG. 4 shows a deduction of $50 for one request. The advice is preferably provided privately to the investor requesting it. The advice, however, could be provided to the audience as a whole.

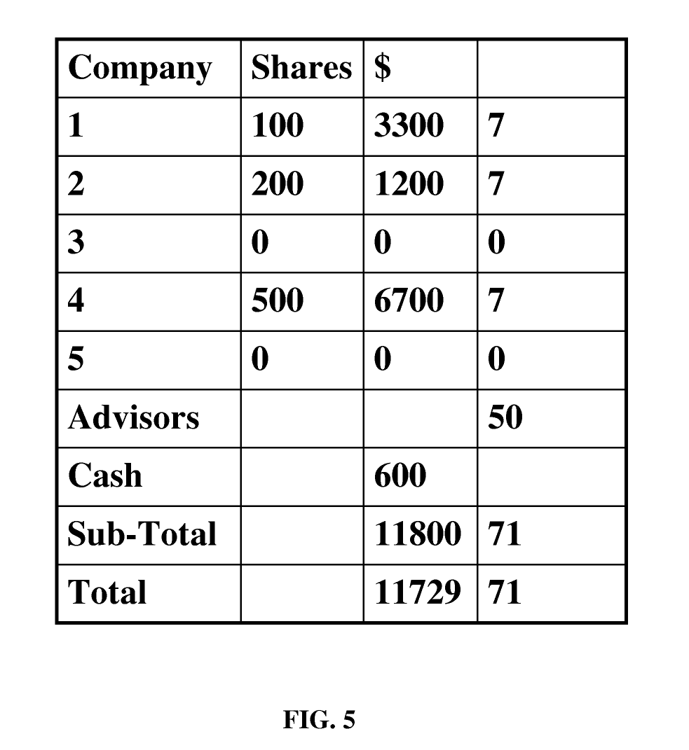

FIG. 5 illustrates tracking the results of each of the plurality of investors and the declaration of a winner in accordance with another aspect of the present invention. The total cash position of each investor 12 to 16 is maintained. The processing system 30 inquires as to the price of the shares of companies 18 to 22 from the database 32. Thus, referring to FIG. 5, Company 1 has gone up $3 per share so that the investor's cash position has risen to $3300. Company 2 has dropped $1 per share so that the cash position has dropped to $1200. Company 4 has gone up $3.40 per share so that the cash position has risen to $6700. In sum, the stock value of the investor has risen to $11,200. Including the cash position of the investor, the total value is $11,800. After deducting expenses, the account value is $11,729.

Similar information is maintained for each investor 12 to 16. Also, similar information can be maintained for each member of the audience 10 or the audience 10 as a whole. At the end of a period, the account value for each investor is determined and a winner is declared.

In accordance with another aspect of the present invention, the investors can meet again to change their investment decisions. Thus, the investors 12 to 16 can redistribute their investments. If old positions are sold and new investments made, then that information is tracked, including all related expenses.

While there have been shown, described and pointed out fundamental novel features of the invention as applied to preferred embodiments thereof, it will be understood that various omissions and substitutions and changes in the form and details of the device illustrated and in its operation may be made by those skilled in the art without departing from the spirit of the invention. It is the intention, therefore, to be limited only as indicated by the scope of the claims appended hereto.

1. A method of presenting a television show, comprising:
providing each of a plurality of investors with a predetermined sum of money;
televising a presentation of information about a plurality of companies to the plurality of investors;
televising each of the plurality of investors investing the predetermined sum of money in the plurality of companies.

2. The method of claim 1, comprising:
tracking the results of the steps of investing the predetermined sum of money for each of the plurality of investors; and
televising the results.

3. The method of claim 2, comprising televising each of the plurality of investors redistributing their investments in the plurality of companies.

4. The method of claim 2, comprising determining which of the plurality of investors has the most money.

5. The method of claim 3, comprising determining which of the plurality of investors has the most money.

6. The method of claim 1, comprising televising each of the plurality of investors redistributing their investments in the plurality of companies.

7. The method of claim 2, comprising deducting an expense for the step of investing the predetermined sum of money for each of the plurality of investors.

8. The method of claim 7, comprising determining which of the plurality of investors has the most money.

9. The method of claim 1, comprising televising one or more of the plurality of investors asking advice from one or more advisors.

10. The method of claim 2, comprising televising one or more of the plurality of investors asking advice from one or more advisors.

11. The method of claim 10, comprising deducting an expense for the step of asking advice.

12. The method of claim 11, comprising determining which of the plurality of investors has the most money.

13. The method of claim 3, comprising televising one or more of the plurality of investors asking advice from one or more advisors.

14. The method of claim 13, comprising deducting an expense for the step of asking advice.

15. The method of claim 14, comprising determining which of the plurality of investors has the most money.

16. The method of claim 1, wherein each of the plurality of companies are start-up companies.

17. The method of claim 1, wherein the presentation of information of each of the plurality of companies is made by a representative of the company.

18. The method of claim 1, wherein each of the plurality of investors is not a professional investor.

19. The method of claim 1, comprising one or more members of an audience watching the presentation of information about the plurality of companies and making investments in the plurality of companies.

20. The method of claim 19, comprising tracking the investment results of one or more members of the audience and determining which one of the one or more members of the audience had the best investment results.
